(19) United States
(12) Patent Application Publication
(10) Pub. No.: US 2010/0111270 A1
(43) Pub. Date: May 6, 2010

(54) Method and apparatus for voicemail management

(75) Inventor: Geoffrey Langos, Manalapan, NJ (US)

Correspondence Address: DUANE MORRIS LLP, Suite 1000, 505 9th Street, N.W., Washington, DC, 20004, US

(73) Assignee: Vonage Holdings Corp.

(21) Appl. No.: 12/289,699

(22) Filed: Oct. 31, 2008

(51) Int. Cl. H04M 11/00

(52) U.S. Cl. 379/88.14

(57) ABSTRACT

Methods and apparatus for managing a media file having media recorded for a user in a communication system. A first message is sent to the user containing text converted from a portion of speech content of the media. A second message is received from the user containing an instruction from the user indicating an operation to be performed on the media file. The operation is performed on the media file in response to the user's instruction in the second message.

### BACKGROUND OF THE INVENTION

The systems and methods disclosed relate to managing media files for a user in a communication system, and more particularly to managing voicemails in a communication system using speech to text conversion and a text based messaging service.

The field of “unified messaging” has developed in response to the challenges of managing a plurality of available communication methods. Wide popularity of messaging services, including various types of voicemail, text messaging, email, fax, instant messaging, paging and the like challenge customers and service providers in attempting to manage and track the messages across different systems, devices and protocols.

Unified messaging is directed to attempts of providing a coherent method of notifying, storing, synchronizing, and forwarding multiple forms of message traffic. Often, efforts in unified messaging are directed to making universal message store, i.e. an inbox, that is controlled by a unified message server. Other efforts are directed to maintaining synchronization between various systems, including email and voicemail.

A related innovation is speech to text conversion, which enables converting a message from a voice format to a text format. For example, Vonage, the VoIP service provider of Holmdel, N.J., U.S.A., markets a service called VONAGE VISUAL VOICEMAIL™. Vonage Visual Voicemail automatically transcribes voicemails to text so that the user can read them as an email or as a short message service text (SMS) on their mobile phones. The user can configure their service to automatically send the transcribed voicemail through existing means, for example to a work email address or to a cell phone in an SMS text message. The speech to text transcription allows users to get the message in meetings or in noisy environments, such as a crowded restaurant or an airport. Receiving a voicemail transcript minimizes the number of times that users have to dial in and navigate to a particular voicemail message. Also, receiving a transcript prevents users from having to take notes or listen repeatedly to the same voicemail just to get some detail like the call back number or an address. Speech to text has the added advantage that the full transcript can be downloaded quickly to accommodate for unreliable cell phone service.

Unfortunately, speech to text alone does not solve the challenges of unified messaging. For example, recipients of a speech to text transcription have limited means of managing the corresponding voicemail. Some speech to text messaging efforts have focused on synchronizing the status of the transcript with the voicemail. This has the unfortunate downside however that users have limited ability to manage the two forms of a message independently. For example, a user may want to delete the voicemail but keep the transcript.

Problems with conventional voicemail systems have not been overcome by unified messaging efforts. Various unified messaging concepts still require a number of steps before a voicemail can be deleted, saved, or otherwise managed. For example, the user may have to dial into a voicemail system, listen to voice prompts and even old messages before finding the message of interest. Once the message is found, then user may have to remember a number code or suffer through a voice tree to learn the number code necessary to manage voicemails over the phone.

More advanced voicemail services provide a web interface. However, a web interface may still require the user to log into the interface and find the message of interest before being able to save, delete or otherwise manage the voicemail. As such, many of the drawbacks of voicemail are not overcome by the prior art.

There remains a need for a method of managing media files such as voicemails that solves or ameliorates at least one of the deficiencies of the prior art.

### SUMMARY

In a first aspect, a method of managing a media file having media recorded for a user in a communication system includes sending a first message to the user containing text converted from a portion of speech content of the media. The method further includes receiving a second message containing an instruction from the user indicating an operation to be performed on the media file and performing the operation on the media file in response to the second message.

In a second aspect, a method of managing a media file in a communication system using a user device includes receiving a first message for a user at the user device, the first message having text converted from a portion of speech content of media recorded for the user in the media file. The method further includes accepting input from the user of an instruction indicating an operation to be performed on the media file by the communication system, generating a second message containing the instruction, and sending the second message from the user device to the communication system.

In various embodiments, the method of the first or second aspect may include one or more of the following features. The operation performed may include saving, deleting, forwarding, playing and combinations thereof. Preferably, the first message may be sent via a text based communication. If preferred, the text based communication may be a mobile telephone text messaging service, a SMS service and an instant messaging service. The instruction may be input by the user in various ways and formats. For example, the instruction may be one or more characters input by the user. The instruction may also be in natural language input by the user. In one embodiment, natural language instructions are processed to determine the operation to be performed. The user may preferably select the instruction from a plurality of preformatted choices. The user may enter the instruction using a predictive text mode limited to instructions readable by the communication system.

In an embodiment, the first message contains text that prompts the user for the instruction. The first and second message may be sent via a text based communication having a text message format and the first and second messages may be formatted in the text message format.

Preferably, the second message contains an unique identifier associated with the media file. In one embodiment the method includes confirming, prior to the step of performing the operation, that the second message contains an unique identifier associated with the media file and an identification of a user device that corresponds to a registration of the user with the communication system.

### BRIEF DESCRIPTION OF THE DRAWINGS

FIG. 1 is a logical flow chart of a method of managing a voicemail.

FIG. 2 is a logical flow chart of a method of managing a voicemail that continues from point A of FIG. 1.

FIG. 3 is a chart of preferred embodiments related to point B of FIG. 1.

FIG. 4 is a schematic representation of a mobile phone displaying a transcribed voicemail.

FIG. 5 is a schematic representation of a personal computer displaying a transcribed voicemail.

### DETAILED DESCRIPTION

Various embodiments of the present invention will now be described with reference to the figures. Like reference numerals refer to like elements. One of ordinary skill in the art will appreciate the applicability of the teachings of the detailed description to other embodiments falling within the scope of the appended claims and equivalents thereto.

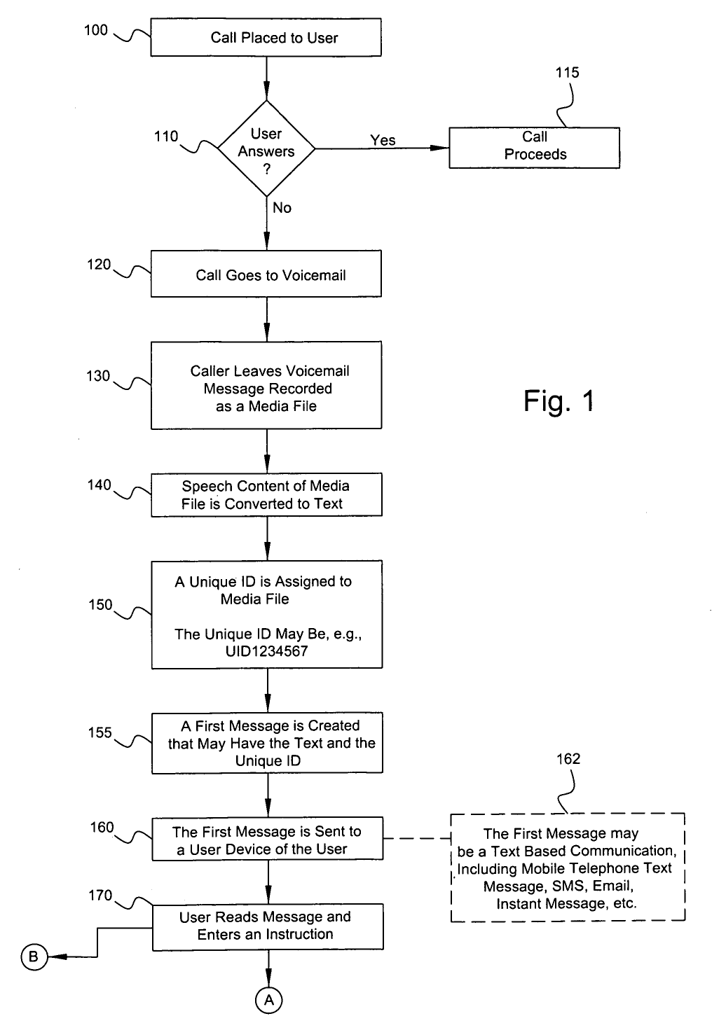

FIG. 1 illustrates steps of a method of managing a voicemail in a communication system. At step 100, a call is placed to a user. The user would typically be a subscriber to a communication service provider. The communication service may be a conventional Plain Old Telephone Service (POTS) provider, a Voice over Internet Protocol (VoIP) provider, a mixture of the two, or the like. In step 110, the communication service attempts to connect the call to the user. Typically the communication service contains user preferences for the user, such that particular user devices are alerted to the incoming call. If the user answers the call, the call proceeds as normal at step 115.

At step 120, if the user does not answer the call, the call proceeds to voicemail. Those of skill in the art will appreciate that the voicemail may be processed by a voicemail system which is operated by a communication service provider or operated by a voicemail provider on behalf of a communication service provider. Similarly, the voicemail system may be an integrated or distinct part of the communication system. In at least one embodiment, the communication system may be nothing more than a pair of user devices communicating with each other. The meaning of communication system includes all of these variations according to the context in which the term appears.

At step 130, the caller leaves a voicemail message for the user which is recorded as a media file. The media file may be a conventional voicemail, or may contain video or other media. In an alternative embodiment, the caller may record the media file at the caller's user device and send the media file to the communication system.

At step 140, speech content of the media file is converted to text. Preferably, the communication system may first determine whether the user (called party) has enabled the speech to text conversion feature. The conversion, also called transcription, may be performed by a speech recognition program such as that marketed as Vonage Visual Voicemail.

Step 150 illustrates an embodiment where a unique identification (UID) number is assigned to the media file. In this example, the UID number is UID1234567. Any form of identification may be used. Depending on the context, the term unique may mean globally unique, locally unique, or unique given a certain parameter such as unique among all media files for a particular user.

In step 155 a first message is created. The first message contains the text converted from the speech content of the media file. The first message may preferably contain the UID. The UID may be embedded in the first message, such as in a tag that is hidden from the user or in a viewable field such as the subject field of an email. The UID may also be included in the content field of the message.

In step 160, the first message is sent to a user device of the user. Preferably, the user has configured the communication system with user preferences. The user preferences may designate, for example, that converted text of all voicemails should be sent via email to one or more email addresses (e.g. work and personal accounts) and to one or more user devices supporting some form of text messaging, such as a SMS text to the user's mobile telephone number. The user device may be any device that supports text based communication with the user, including for example mobile phones, personal data assistants (PDAs), computers, and the like.

As shown by block 162, the first message is preferably sent as a text based communication. The text based communication may be, for example, a mobile telephone text message, a SMS, an instant message, an email or the like.

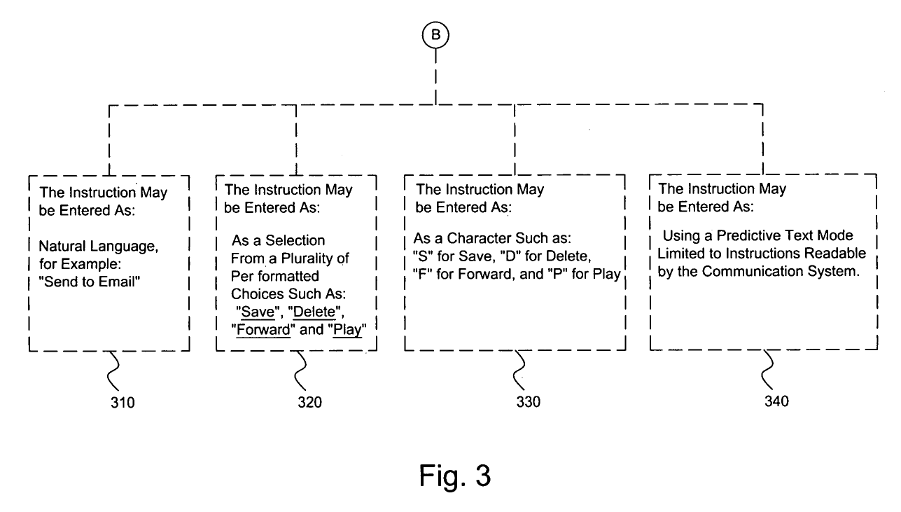

At step 170, the user reads the message and replies by entering an instruction indicating an operation to be performed on the media file. Typical instructions may be to delete or save the media file. Various types of instructions and methods for entering the instructions will be discussed below with respect to FIG. 3.

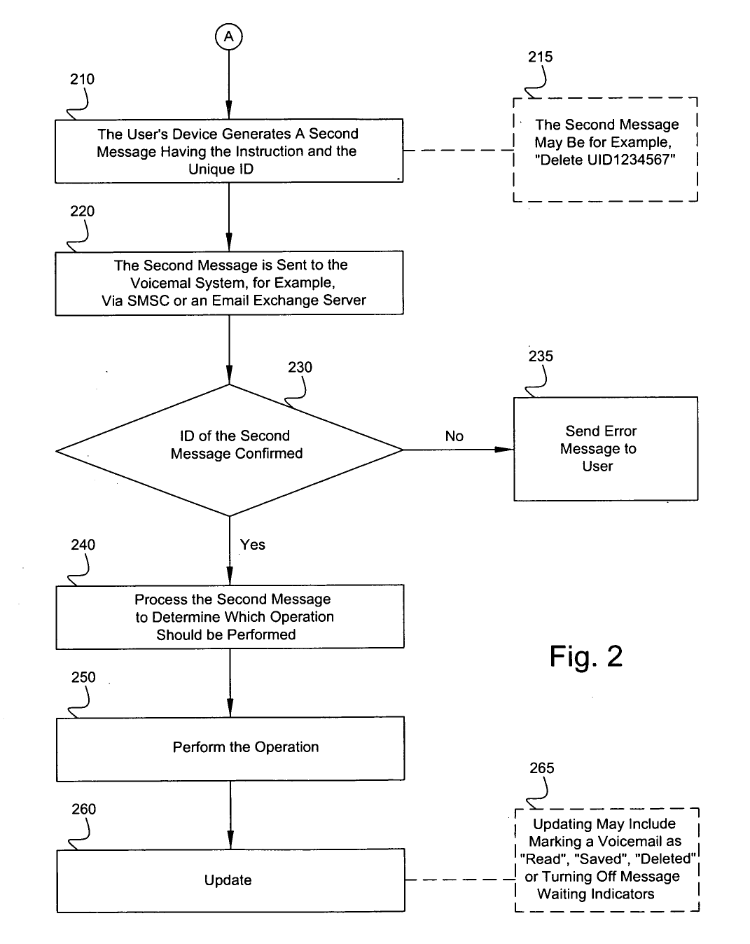

Referring now to FIG. 2, at step 210 the user device generates a second message that preferably contains the instruction and the UID. As illustrated in block 215, the second message may be, for example, “Delete UID 1234567”. At step 220, the second message is sent to the voicemail system. The second message may be sent via an established communications medium, for example, via a short message service center (SMSC) or an email exchange server.

In various embodiments, the first and second messages are sent via a text based communication service having a text message format and the first and second messages are formatted in the text message format. In these embodiments, the second message may typically be a simple reply to the first message such as a reply to an email.

At step 230, it is determined whether both the UID and the user device from which the second message came are confirmed. Confirmation includes the communication system determining whether the UID is recognized and whether the user device identification, for example, the telephone number, caller id, email account, SIM card id or registration or the like, is one that the user has registered with the communication system or is one that the communication system recognizes. In another embodiment, more restrictive confirmation may be used. For example, confirmation may require that both the UID and the identification of the user device were registered as the destination of the first message. Preferably, the level of confirmation may vary with the type of operation to be performed on the media file. For example, a delete operation may present a greater system vulnerability to attackers and thus the communication system may be configured to implement a more restrictive confirmation scheme. On the other hand, a save operation may be routine and relatively safe, requiring no confirmation.

Confirmation may also include checking a user's preferences to determine whether the user has enabled enhanced processing of their voicemails. For example, a communication system may offer speech to text, without the enhanced processing described here. A user that replies to the first message, but who does not have enhanced processing enabled would fail the confirmation step.

If the confirmation fails, an appropriate error message is sent to the user at step 235. For example, if the confirmation failed because the user hasn't enabled enhanced voicemail, the error message would notify the user of that fact. Preferably, the error message may prompt the user to enable the enhanced processing feature by replying to the error message.

If the confirmation succeeds, then the second message is processed to determine which operation should be performed on the media file. One will appreciate that the confirmation may occur after the processing, for example, in embodiments where the level of confirmation depends on the type of operation to be performed. Determining the operation depends on the format of the instruction and will be discussed further with respect to FIG. 3 below.

At step 250, the operation is performed. For example, if the operation is delete, then the voicemail system deletes the media file with the appropriate UID. Multiple operations may be used. Typical operations may be the save, delete, forward and play operations. A forward operation may direct the media file to be sent to a user device. For example, forwarding to the user's email account may include forwarding a copy of the media file as an attachment, for example as a .wav file. The play operation may include a direction for the communication system to place a call to the user that plays the message when the user answers. Furthermore, a user may direct a combination of options. For example, the user may want the media file to be both saved and played.

At step 260, updates occur according to the operation performed. For example, block 265 lists preferable updates that include changing status identifiers of the voicemail to “read”, “saved”, or “deleted” and turning off message waiting indicators. Message waiting indicators may include the voicemail waiting icon typically found on mobile phones, flashing lights on telephones, and the like.

In various embodiments, a user profile maintained by the service provider can be used to manage the preferences and sequencing of the processes disclosed herein to a great degree of flexibility. For example, the user profile may be used with sequential logic according to the preferences of the user, the capabilities of the service provider, security concerns, and compromises among the same. For example, the user profile may include default settings changeable by the user, such as a setting to automatically delete a media file unless a save command is received within a set period of time. Similarly, the user may enter preferred user devices in a preferred sequence. For example, a user may prefer transcribed text to be sent to their email account, then to a mobile phone. Likewise, sequential logic may streamline the various processes disclosed herein. For example, upon recording of a voicemail, the communication system may check the user profile to determine whether enhanced message processing is enabled. If not, the communication system may increase security requirements and send the speech content of the voicemail as transcribed text with a message that also informs the user that enhanced processing can be enabled by taking certain steps. Similarly, the communication system may check the user profile and activate particular security measures based on parameters such as the selected mode of communicating the transcribed text, the length of time that a user account has been open, the frequency with which a user uses a particular feature or the like.

In several embodiments, the user is thus able to manage voicemails without having to use the voicemail system. In many cases, the user may be satisfied with the first message and will elect to simply delete the media file storing the voicemail. For example, the media file may have little value when the transcript appears to have captured the content of the speech. Similarly, if the transcript shows that the message has little content, there is little need to keep it. For example, the user is spared from having to use the voicemail system to delete a message that is on the order of “call me.” The user is likely to want to delete the media file in that instance without ever having listened or watched it. In other instances, the user may want to listen to the message, for example, when the transcript is vague and the user wants to hear the tone of the voice. In those instances, the user is still spared from logging into the voicemail system. Rather, when the user is ready to listen to the message, they may simply reply to the transcript with an instruction to call the user and play the message.

Referring now to FIG. 3, alternative methods related to point B of FIG. 1 are illustrated. In block 310, the user may enter an instruction using natural language. For example, the first message might end with a query such as “What should we do with the voicemail?” The user could respond in any number of ways, even for the same operation. For example, to save the voicemail, the user might spell, for example: “store”, “save it”, “store it in voicemail”, or “save it and send a copy to my email.” In this embodiment, the processing in step 240 of FIG. 2 is more involved. Techniques for natural language processing have been developed at least with respect to natural language search engines. If the appropriate operation is unable to be determined from the natural language instruction, an error message may be sent to the user. Alternatively, the error may result in alerting an service agent of the communication service provider. In yet another embodiment, a message may be sent to the user that presents preformatted choices to the user, such as in block 320.

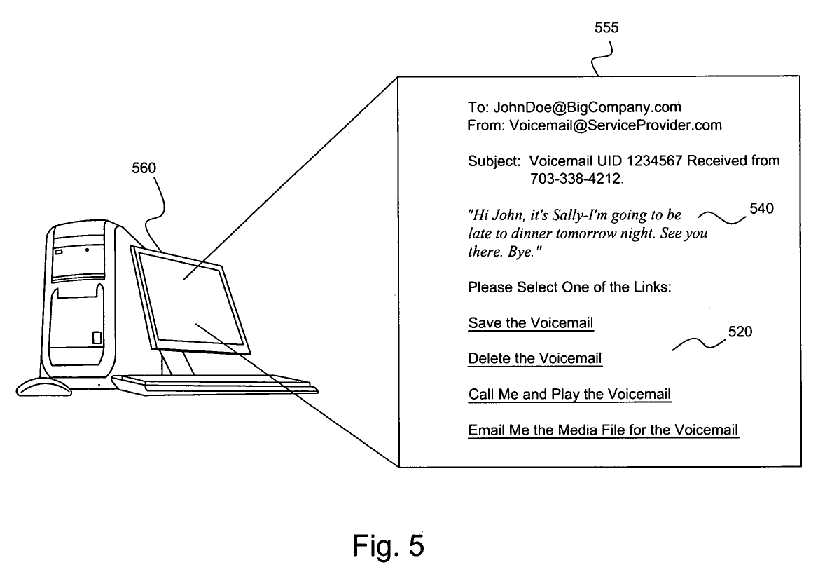

In block 320, the user selects from a plurality of preformatted choices. This method has the advantage that the user selection may be returned in a form that is readily readable by the system that performs the operation. In this embodiment, the second message may not be in the format of a text based message. For example, consider the email 555 depicted in FIG. 5. In this embodiment, the user device is an email account displayed on computer 560. In the email, the text 540 has been converted from the speech portion of the voicemail. A plurality of preformatted choices 520 appear as executable links in the body of the email. While the user may have fewer options, the preformatted choices are less prone to error.

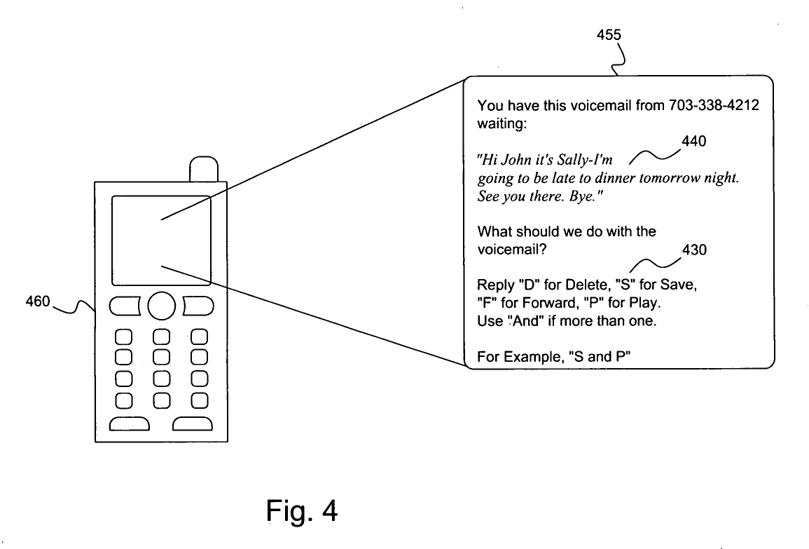

Referring again to FIG. 3, another method is depicted at step 330. In this method, the first message prompts the user to reply with particular characters or words. For example, step 330 prompts the user to reply with “s” for save, “d” for delete, “f” for forward, and “p” for play. This depicted in FIG. 4, where text message 455 is displayed on a user device that is mobile phone 460. The text 440 has been converted from the speech content of a voicemail. The prompts 430 let the user know which characters may be used to achieve various operations on the media file. The prompts may likewise suggest full words.

An alternative method of entering the instruction using predictive text is depicted in step 340. In general, predictive text algorithms are commonly used on mobile phones to assist users in quickly typing words using only a subset of the characters in the word. Predictive text algorithms predict which word the user intends based on the initial key strokes made. Predictive text may find utility in entering the instruction. For example, in step 340, the instruction is entered using a predictive text mode of entry that is limited to instructions readable by the communication system. When a user replies to a first message, the user device may initiate the predictive text mode. For example, when the user depresses the number key corresponding to “S”, the predictive text algorithm predicts either “save” or “send to”.

In addition to the specific embodiments described above, further alternative embodiments will now be described. While a telephone call is used to illustrate the embodiments above, the invention is not so limited. For example, it is expected that video calls may begin to be used that have both video and audio components. The term “media file” is intended to include such formats.

In an alternative embodiment, it is expected that callers may pre-record voice and/or video messages and deliver them to the user via a communication service provider. Likewise, it may be the case that the calling party has a user device that transcribes the speech portion of such a message and delivers the text or the text with a media file to the communication service provider. For example, if a caller records a short video message for someone using their mobile phone and attempts to send the video as a multimedia message, the method and apparatus disclosed in this application may find particular utility in managing the media file. A transcript of the multimedia message may be sent to the user first, allowing the user to then manage what happens to the media file using a reply instruction.

In one embodiment, the text based communication may operate partially or completely peer to peer between two user devices with respect to the media file. For example, a first user at a computer could record a video message for a second user. The first user's computer may transcribe the speech content of the video to text and store the video message for a predefined time. The first computer could place the transcribed text in an email sent to the second user. The second user could then select an instruction to delete or send the media file. Such a configuration has the advantage of distributing storage needs among users and prevents unnecessary transmission and storage of media.

In a further alternative embodiment, the UID may not be sent in the first or second message. Rather, the voicemail system may use a system of pointers that associates the second message with the first message,with the media file of interest. For example, when the first message is generated, an identification of the first message may be associated with the media file. The second message may then be generated with an identification of the first message. When the second message is received, the voicemail system may, for example, compare the message associations to identify the appropriate media file. Alternative methods of associating media files with communications are known and not beyond the scope of the invention.

While preferred embodiments of the present invention have been described in detail, it is to be understood that the embodiments described are illustrative only. From this specification, those skilled in the art will appreciate numerous and varied other embodiments within the spirit and scope of the invention. The scope of the invention is to be defined not by the preferred embodiments, but solely by the appended claims and equivalents thereof.

I claim:

1. A method of managing a media file in a communication system having media recorded for a user, the method comprising:
sending a first message to the user containing text converted from a portion of speech content of the media;
receiving a second message containing an instruction from the user indicating an operation to be performed on the media file; and
performing the operation on the media file in response to the second message.

2. The method of claim 1 wherein the operation is selected from the group consisting of: save, delete, forward, play and combinations thereof.

3. The method of claim 1 wherein the first message is sent as a text based communication.

4. The method of claim 3 wherein the text based communication is selected from the group consisting of: a mobile telephone text message, a SMS and an instant message.

5. The method of claim 1 wherein the instruction comprises at least one character input by the user.

6. The method of claim 1 wherein the instruction comprises natural language input by the user.

7. The method of claim 6 wherein the step of performing the operation comprises processing the natural language to determine the operation.

8. The method of claim 1 wherein the user selects the instruction from a plurality of preformatted choices.

9. The method of claim 1 wherein the user enters the instruction using a predictive text mode limited to instructions readable by the communication system.

10. The method of claim 1 wherein the first message contains text that prompts the user for the instruction.

11. The method of claim 1 wherein the first and second message are sent via a text based communication service having a text message format and the first and second messages are formatted in the text message format.

12. The method of claim 1 wherein the second message contains an unique identifier associated with the media file.

13. The method of claim 1 further comprising the step of confirming, prior to the step of performing the operation, that the second message contains an unique identifier associated with the media file and an identification of a user device that corresponds to a registration of the user with the communication system.

14. A method of managing a media file in a communication system using a user device, the method comprising:
receiving a first message for a user at the user device, the first message having text converted from a portion of speech content of media recorded for the user in the media file;
accepting input from the user of an instruction indicating an operation to be performed on the media file by the communication system;
generating a second message containing the instruction; and
sending the second message from the user device to the communication system.

15. The method of claim 14 wherein the operation is selected from the group consisting of: save, delete, forward, play and combinations thereof.

16. The method of claim 14 wherein the first message is received as text based communication.

17. The method of claim 16 wherein the text based communication is selected from the group consisting of: a mobile telephone text message, a SMS and an instant message.

18. The method of claim 14 wherein the instruction comprises at least one character input by the user.

19. The method of claim 14 wherein the instruction comprises natural language input by the user.

20. The method of claim 19 wherein the step of performing the operation comprises processing the natural language to determine the operation.

21. The method of claim 14 wherein the user selects the instruction from a plurality of preformatted choices.

22. The method of claim 14 wherein the user enters the instruction using a predictive text mode limited to instructions readable by the communication system.

23. The method of claim 14 wherein the first message contains text that prompts the user for the instruction.

24. The method of claim 14 wherein the first and second message are sent via a text based communication service having a text message format and the first and second messages are formatted in the text message format.

25. The method of claim 14 wherein the second message contains an unique identifier associated with the media file.

26. The method of claim 14 wherein the second message contains an unique identifier associated with the media file and an identification of the user device that corresponds to a registration of the user with the communication system.

27. The method of claim 14 further comprising performing the operation.
